(19) United States
(12) Patent Application Publication
(10) Pub. No.: US 2016/0034569 A1
(43) Pub. Date: Feb. 4, 2016

(54) SEARCH DEVICE

(71) Applicant: KABUSHIKI KAISHA TOSHIBA, Tokyo (JP)

(72) Inventors: Toshiaki Nakasu, Tokyo (JP); Yuto Yamaji, Kawasaki Kanagawa (JP); Tomoyuki Shibata, Kawasaki Kanagawa (JP); Kazunori Imoto, Kawasaki Kanagawa (JP); Isao Mihara, Tokyo (JP)

(21) Appl. No.: 14/812,770

(22) Filed: Jul. 29, 2015

(30) Foreign Application Priority Data
Jul. 30, 2014 (JP) 2014-154875

(51) Int. Cl. G06F 17/30; G06K 9/22

(52) U.S. Cl. CPC G06F 17/30696; G06F 17/30277; G06K 9/222; G06F 17/3071

(57) ABSTRACT

A storage stores a classified-component-presence region where a component is present which constitutes one or more items of content while associating the classified-component-presence region with the respective one of the items of content. An acquisition controller acquires designation data designating a second region which is present around a first region equivalent to the classified-component-presence region of an item of content to be searched for and limits a likelihood of presence of the component. A search controller searches the item of content to be searched for from those stored in the storage based on the designation data. A display controller displays a search result on a display.

### CROSS-REFERENCE TO RELATED APPLICATIONS

This application is based upon and claims the benefit of priority from Japanese Patent Application No. 2014-154875, filed Jul. 30, 2014, the entire contents of which are incorporated herein by reference.

### FIELD

Embodiments described herein relate generally to a search device.

### BACKGROUND

Conventionally, techniques of searching for documents based on a handwritten query entered by the user are known. For example, there is a technique of searching for material with reference to an annotation (handwriting data) written on a paper material.

However, with the conventional technique mentioned above, those documents cannot be searched for when the location of a component (for example, character region, figure region, photo, etc.) on a document to be searched for cannot be well remembered.

### BRIEF DESCRIPTION OF THE DRAWINGS

FIG. 1 is a block diagram showing a structure of a search device according to the first embodiment.

FIG. 2 is a diagram showing an example of a content item to be searched for in this embodiment.

FIG. 3 is a diagram showing an example of handwriting data in this embodiment.

FIG. 4 is a diagram showing an example of a search result in this embodiment.

FIG. 5 is a diagram showing an example of a content item to be searched for in this embodiment.

FIG. 6 is a diagram showing an example of handwriting data in this embodiment.

FIG. 7 is a diagram showing an example of handwriting data in this embodiment.

FIG. 8 is a diagram showing an example of handwriting data in this embodiment.

FIG. 9 is a diagram showing an example of handwriting data in this embodiment.

FIG. 10 is a diagram showing an example of handwriting data in this embodiment.

FIG. 11 is a flowchart illustrating an example of a search process executed by a search device 10 of this embodiment.

FIG. 12 is a diagram showing an example of handwriting data together with a search result in this embodiment.

FIG. 13 is a diagram showing an example of handwriting data in the second embodiment.

FIG. 14 is a diagram showing an example of handwriting data in the fourth embodiment.

FIG. 15 is a diagram showing an example of handwriting data in Modification 1.

FIG. 16 is a diagram showing an example of handwriting data together with a search result in Modification 1.

FIG. 17 is a diagram showing an example of handwriting data together with a search result in Modification 2.

FIG. 18 is a diagram showing an example of a content item to be searched for in Modification 3.

FIG. 19 is a diagram showing an example of handwriting data in Modification 3.

FIG. 20 is a diagram showing an example of a hardware configuration of a search device in each of the embodiments and modifications.

### DETAILED DESCRIPTION

Embodiments will now be described with reference to drawings.

A search device according to an embodiment includes a storage, an acquisition controller, a search controller and a display controller.

The storage stores one or more items of content and stores a classified-component-presence region where a component is present which constitutes a respective one of the one or more items of content while associating the classified-component-presence region with the respective one of the items of content. The acquisition controller acquires designation data designating a second region which is present around a first region equivalent to the classified-component-presence region of an item of content to be searched for and limits a likelihood of presence of the component. The search controller searches the item of content to be searched for from those stored in the storage based on the designation data acquired by the acquisition controller. The display controller displays a search result obtained by the search controller on a display.

The search device may be used in pen-tablets, tablet PCs, etc., in which, for example, the user can enter handwritten information using a digital pen (stylus). The search device is configured to analyze a preregistered document and search using language information obtained as a result of the analysis. Further, the search device can extract non-language information from the document and search using the non-language information. The non-language information includes layout information, color tone, density, etc.

The following are examples of the search technique using non-language information.

(a) Method of designating a region in which a component (a character, figure, table or the like) which constitutes an item of content to be searched for is present; and

(b) Method of designating a region where no components are present (that is, a margin or the like).

The first embodiment will now be described in connection with the method (a) above, and the second and third embodiments in connection with the method (b).

### First Embodiment

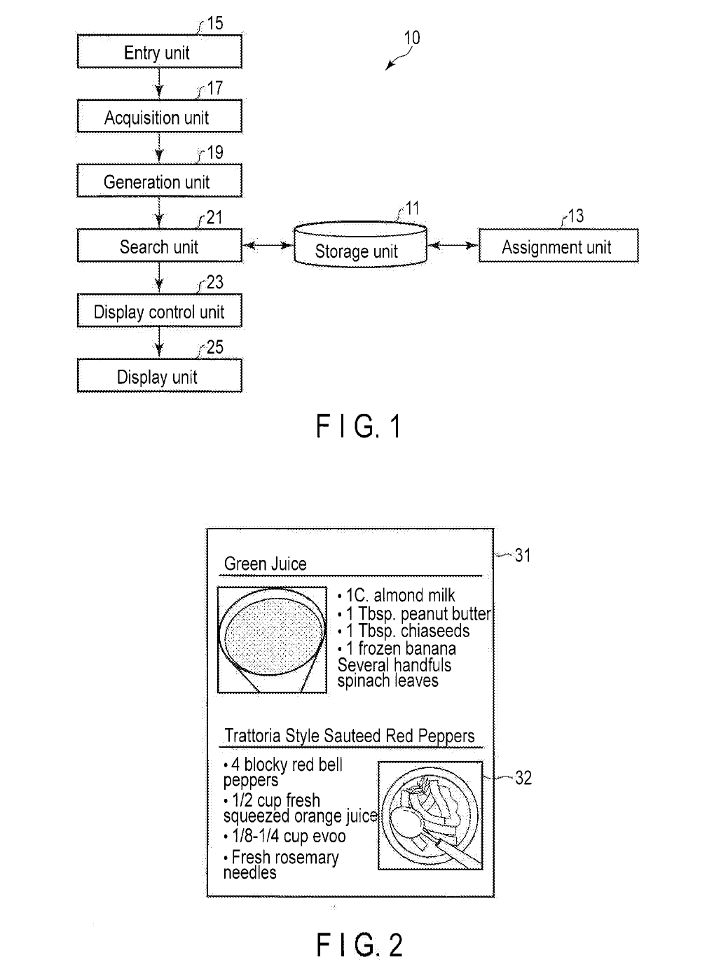

FIG. 1 is a block diagram showing a structure of a search device according to the first embodiment.

As shown in FIG. 1, a search device 10 comprises a storage unit 11, an assignment unit 13, an entry unit 15, an acquisition unit 17, a generation unit 19, a search unit 21, a display control unit 23 and a display unit 25.

The storage unit 11 may be a storage device which can store data magnetically, optically or electrically, such as a hard disk drive (HDD), a solid state drive (SSD), a memory card, an optical disk, a read only memory (ROM) or a random access memory (RAM).

The assignment unit 13, the acquisition unit 17, the generation unit 19, the search unit 21 and the display control unit 23 may be realized by software which makes a processing unit such as central processing unit (CPU) to execute programs. Alternatively, these units may be realized by hardware such as integrated circuits (ICs), or even software and hardware may be used in combination.

The entry unit 15 may be, for example, a touchpanel, a touchpad, a mouse or electronic pen (stylus). The display unit 25 may be, for example, a touchpanel display or a liquid crystal display.

With the structure described above, the storage unit 11 is configured to store one or more items of content. The content includes documents formed by “document preparation software”, “spreadsheet software”, “presentation software”, “document viewer software” and the like. Further, the content includes digital documents such as web pages, documents created and entered by handwriting, and the like. The content is not limited to these, but may be still images, moving images, etc.

The assignment unit 13 is configured to analyze the content stored in the storage unit 11 separately, The assignment unit 13 generates structural data indicating locations of components which constitute each item of content based on the result of the analysis and relative locational relationships among the components and classifications of the components, and assigns the structural data to the respective item of content.

The components are regions on content, which can be recognized by the user. The locations of the components are, for example, coordinate information on a page. That is, the assignment unit 13 assigns a central coordinate of a region in which a component is present (to be referred to as classified-component-presence region) or the like, as the location of the component. The relative locational relationship among components can be specified from the location (coordinate information) of each component. Thus, the storage unit 11 stores classified-component-presence regions in which components of each content item are present, while associating each region with each respective item of content.

Classifications of the components are at least one of, for example, characters, figures, tables, images, illustrations, formulas, maps and memos (annotations) added by the user.

When the classification of a component is of characters, the classification may be further specified into paragraphs, lines, words, a letter, a radial (of Chinese character) and the like. When the classification of a component is of figures and tables, the classification may be further specified into straight lines, triangles, rectangles, circles and the like. When the classification of a component is of images, the classification may be further specified into objects within the image and edges.

In order to recognize an object in an image, for example, the object recognition method disclosed in the following may be used.

“Jim Mutch and David G. Lowe. Multiclass Object Recognition with Sparse, Localized Features. IEEE Conference on Computer Vision and Pattern Recognition (CVPR), pp. 11-18, New York, June 2006.”

An edge is a border line at which the brightness and/or color sharply change within an image.

Note that the classification of a component may be set by, for example, colors such as red, blue and green, or by densities such as thick and thin.

When the content item is a digital document, the document contains, as document data, information with which the locations of components, the relative locational relationship among the components and the classifications of the components can be specified. Therefore, when the content item is a digital document, the assignment unit 13 can generate structural information by analyzing the content item.

When the content item is a handwritten document, strokes which constitute handwriting data, the classes to which the strokes belong and the locations thereof can be analyzed. In this manner, the locations of components, the relative locational relationship among the components and the classifications of the components can be specified.

Classes of the components are at least one of, for example, characters, figures, tables, images, illustrations, formulas, maps and memos (annotations) added by the user. Therefore, the assignment unit 13 can generate structural information by analyzing the content even if the content is handwriting data.

A class to which a stroke belongs may be determined as follows.
A set of strokes are grouped in spatial or temporal of structures. In units of structures, a class of a stroke belonging to the structure is determined.
For each stroke, one or more adjacent strokes present around the respective stroke are extracted. Then, a combination characteristic amount regarding characteristics of combination of the stroke and the extracted one or more adjacent strokes is calculated. Based on the calculated combination characteristic amount, the class to which the stroke belongs is determined.

The combination characteristic amount contains a first characteristic amount indicating a relationship between an object stroke and at least one of the one ore more adjacent strokes. The combination characteristic amount contains a second characteristic amount obtained using a value of a sum total of a characteristic amount regarding a shape of an object stroke and a characteristic amount regarding a shape of each of the one or more adjacent strokes.

The first characteristic amount is at least one of a similarity and a specific value, described below.
similarity in shape between an object stroke and at least one of one or more adjacent strokes
specific value specifying a locational relationship between an object stroke and at least one of one or more adjacent strokes

The similarity in shape between an object stroke and at least one of one or more adjacent strokes involves at least one of “length, curvature in total, direction of main component, area of circumscribed rectangle, length of circumscribed rectangle, aspect ration of circumscribed rectangle, distance between start point and end point, direction density histogram and the number of inflection points”. In other words, the similarity in shape is a similarly between a stroke characteristic amount of an object stroke and a stroke characteristic amount of at least one of one or more adjacent strokes.

The specific value between an object stroke and at least one of one or more adjacent strokes involves at least one of “overlapping ratio of circumscribed rectangle, centroidal distance, direction of centroidal distance, endpoint distance, direction of endpoint distance and the number of intersections”.

The first characteristic amount is at least one of the followings.
ratio between a length of circumscribed rectangle of combination and a total of a length of an object stroke and lengths of the one or more adjacent strokes
total sum of directional density histograms of an object stroke and the one or more adjacent strokes
ratio between an area of circumscribed rectangle of combination and a total of an area of a circumscribed rectangle of object stroke and areas of circumscribed rectangles of the one or more adjacent strokes

The entry unit 15 is configured to enter handwriting data designating a region in which a component constituting content to be searched for is contained, to the search device 10. Handwriting data may further designate a classification of each of components. Handwriting data comprises a plurality of strokes.

Here, when a location of a component should be designated, a first region equivalent to a classified-component-presence region where the component is present is designated.

On the other hand, when an exact location of a component is not clearly remembered, a second region which limits likelihood of presence of the component is designated, which indicates that “the target component is present somewhere in this zone”. In other words, the second region, which is located around the first region and where the likelihood of presence of the target component is at a threshold value or more, designated.

The “likelihood” is an index indicating a certainty. For example, when the classification of a component is a character, the first region indicates a region where characters are certainly present. On the other hand, the second region indicates where characters may have been present.

In the first embodiment, a plurality of components of an item of content to be searched for are present on a page, and locations of these components are on the same page. But the embodiment is not particularly limited to this structure.

Further, the first embodiment is described on the assumption that the entry unit 15 is a touchpanel, on which the user enters handwriting data of at least one of figures, illustrations, characters and the like using a stylus pen or finger by handwriting. Here, as well, the embodiment is not limited to this, but the entry unit 15 may be realized by a touchpad, a mouse, an electronic stylus or the like.

A stroke is one continuous part of a figure, illustration, character or the like handwritten by the user, that is, data indicating a locus from a point where a stylus pen or finger contacts the entry surface of the touchpanel to a point where it is detached (from a pen-down to a pen-up). A stroke can be represented as time-series coordinates of contact points, for example, between a stylus pen or finger and the entry surface.

Note that the designation method is not necessarily limited to handwriting data. For example, templates for the classifications including various shapes of patterns, “figures”, “tables” and the like may be prepared in advance, and the region shapes and classifications may be designated using these templates.

The acquisition unit 17 is configured to acquire handwriting data entered from the entry unit 15.

The generation unit 19 is configured to shape handwriting data acquired by the acquisition unit 17 and generate a search query. More specifically, the generation unit 19 subjects the handwriting data acquired by the acquisition unit 17, to character recognition, figure recognition, table recognition, image recognition and the like, to generate a search query.

The search unit 21 searches for target content to be searched for from those stored in the storage unit 11 based on the handwriting data obtained by the acquisition unit 17. The search unit 21 refers to structural information on each of one or more items of content stored in the storage unit 11 to search an item of content to be searched for.

More specifically, the search unit 21 compares the search query generated by the generation unit 19 with the structural data of each of the one or more items of content stored in the storage unit 11 in the searching of an item of content to be searched for. For example, the search unit 21 is configured to search content whose similarity between the search query and the structural information exceeds a threshold, as the object item of content to be searched for from the one or more contents stored in the storage unit 11.

The similarity may be defined as, for example, a ratio of an area in which a region designated by the user and a classified-component-presence region in an object item of content to be searched for overlap, occupying the area of the classified-component-presence region. Thus, when the classified-component-presence region is entirely contained somewhere in the region designated by the user, the similarity is 100%.

The timing for starting a search may be when the search command is detected. A search command may be generated when the user presses the search button or carries out predetermined writing (see Patent Literature 2).

One or more items of content stored in the storage unit 11 are each able to derive a location of each of components constituting the item of content itself, a relative locational relationship among components and a classification of each of the components.

The search unit 21 is configured to analyze each item of content stored in the storage unit 11, and derive the location of each of the components, the relative locational relationship among the components and the classification of each of the components based on the result of analysis. The search unit 21 may compare these with a search query generated by the generation unit 19 to search an item of content to be searched for. In this manner, a target content item can be searched for even if structural information is not assigned to the content item by the assignment unit 13.

The display control unit 23 is configured to display a search result obtained by the search unit 21 on the display unit 25.

Next, the search method of the first embodiment will now be described.

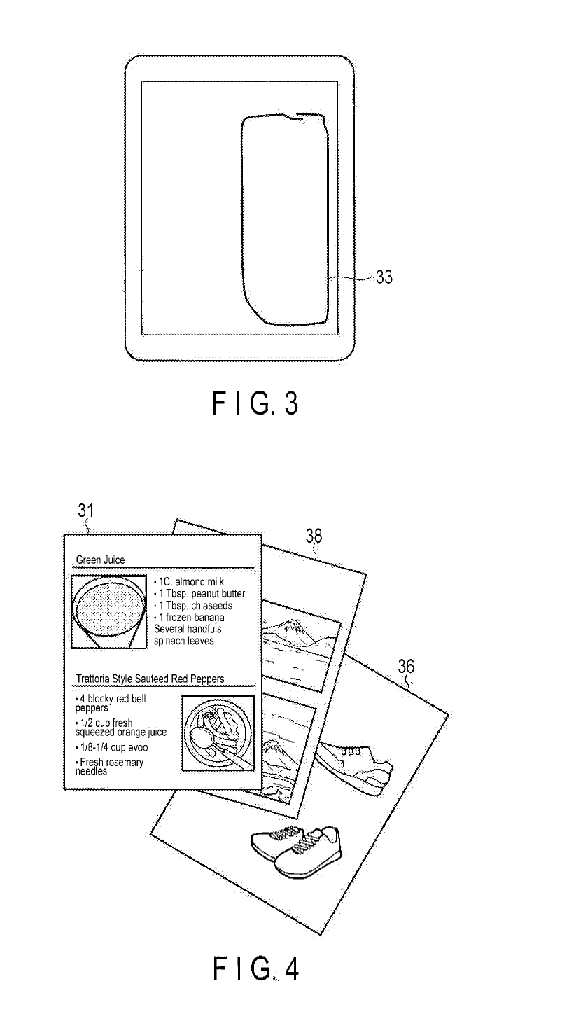

FIG. 2 shows an example of the content item to be searched for. FIG. 3 shows an example of the handwriting data. FIG. 4 shows an example of the search result.

Let us suppose a case where there is a region 32 for an image (photo) at the lower right of a target content item 31 to be searched for as shown in FIG. 2. In this case, as shown in FIG. 3, the user enters handwriting data indicating that the classification is image and designating the region 33 located on the right of the page, to the search device 10 through the entry unit 15. More specifically, for example, an image designation mode is selected from a menu (not shown), and the region 33 indicating an image is designated by handwriting.

The generation unit 19 shapes the handwriting data entered and generates a search query. In detail, the generation unit 19 recognizes, for example, the region of the closed loop located on the right side of the page and the classification thereof, and creates the search query from these information.

The search unit 21 compares the search query generated by the generation unit 19 with the structural information of each of the one or more contents stored in the storage unit 11. Thus, the search unit 21 searches for an item of content whose similarity between the search query and the structural information exceeds a threshold, that is, searches for an item of content in which an image region is located somewhere in a right side of a page thereof. In this manner, as shown in FIG. 4, a content item 31 to be searched for, a content item 36 and a target content item 38 are obtained as search results, and of these, the target content item 31 is displayed on the display unit 25.

Next, specific examples of handwriting data (search query) will now be described.

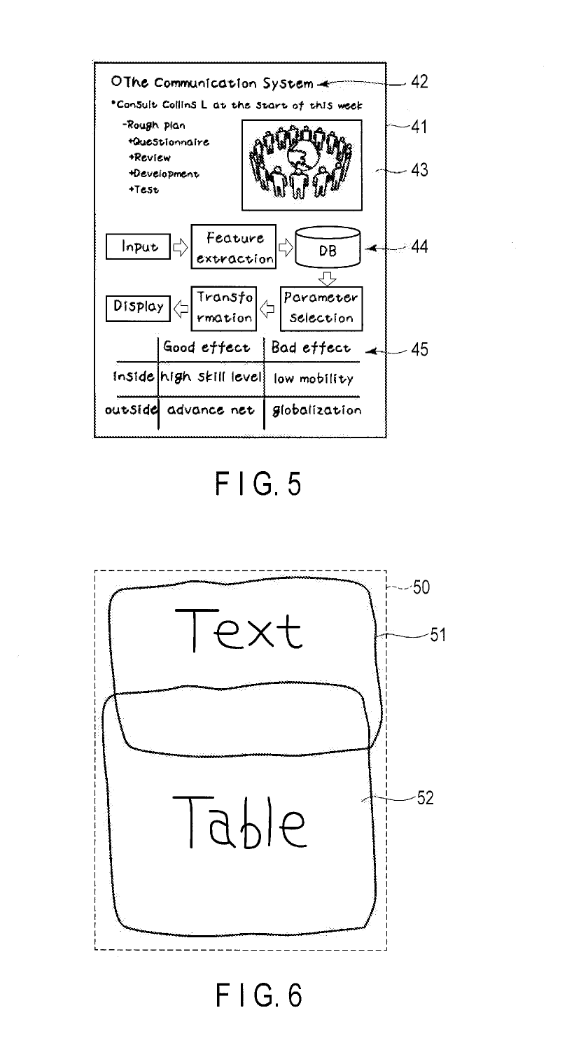

FIG. 5 shows an example of an item of content to be searched for. FIGS. 6 to 10 each show an example of handwriting data.

Let us suppose that a content 41 item to be searched for contains in an upper left section thereof a region 42 of characters as shown in FIG. 5. Further, the content 41 also contains a region 43 of an image (photo) in an upper right section thereof, a region 44 of a figure in a middle section, and a region 45 of a table in a lower section.

In connection with this, FIGS. 6 to 10 show possible examples of handwriting data to be entered as a key to search for the content item 41.

### Example 1

The handwriting data shown in FIG. 6 designates the following items by arbitrary circular or polygonal figures entered by handwriting at respective locations of components which constitute the item of content to be searched for, and characters entered by handwriting within the figures.
regions containing locations of components of an item of content to be searched for
relative relations among regions
classifications of the components

In the example of FIG. 6, a polygon 51 encircling characters is handwritten in an upper section of a page 50, designating that a character region is present somewhere in the upper section. Further, a polygon 52 encircling a table is handwritten in a lower section of the page 50, designating that a table region is present somewhere in the lower section.

When the classification of a component is character, various patterns, for example, “text”, “character”, “character string” and “sentence” may be prepared as well. In the example of FIG. 6, handwriting “Text” in the polygon 51 indicates that characters are present in the region encircled by the polygon 51.

When the classification of a component is table, for example, various patterns such as “Table”, “Chart” and “Matrix” may be prepared in advance. In the example of FIG. 6, handwriting “Table” in the polygon 52 indicates that a table is present in the region encircled by the polygon 52.

When the classification of a component is designated by handwritten characters as shown in FIG. 6, it is necessary for the generation unit 19 to recognize the handwritten characters to generate a search query.

Note that in the example of FIG. 6, handwriting characters are provided at the respective locations of the components constituting the content, but they may be substituted by an icon or stamp which indicates the classification of the components. Further, the color may be designated as well, that is, each region of handwriting data may be written with a pen indicating the color of the object to be searched for. Or, a character indicating a color such as “blue” or “red” may be written in each region of handwriting data.

### Example 2

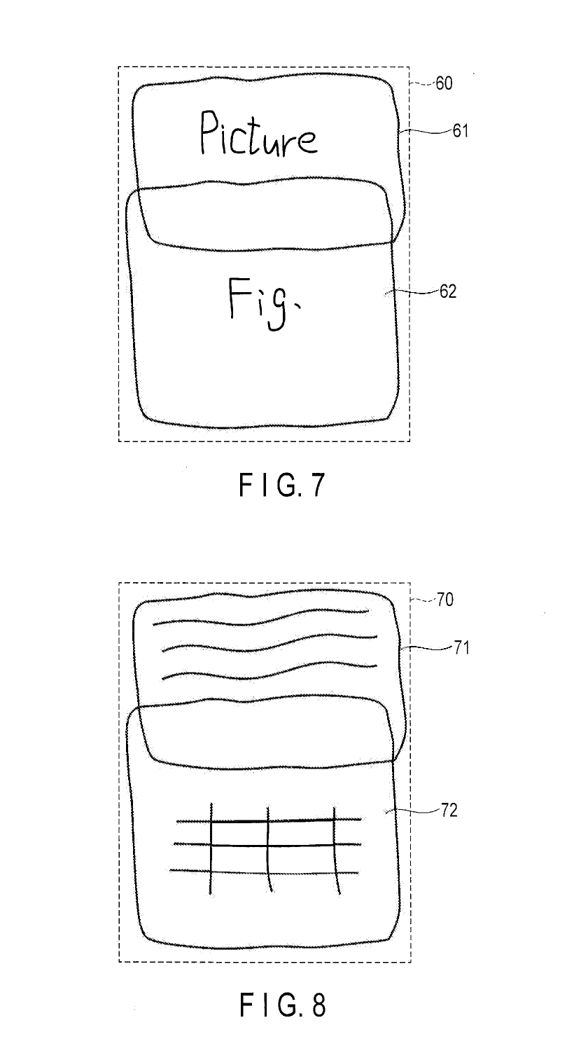

The handwriting data shown in FIG. 7 designates a classification different from that of FIG. 6. In this example, handwriting a polygon 61 containing a picture on a page 60 in an upper section thereof designates that there is a picture region somewhere in the upper section. Further, handwriting a polygon 62 containing a figure on the page 60 in a lower section thereof designates that there is a figure region somewhere in the lower section.

“Picture” handwritten in the polygon 61 indicates that the classification of the component is a photo. “Fig.” handwritten in the polygon 62 indicates that the classification of the component is a figure.

### Example 3

The handwriting data shown in FIG. 8 designates the following items by arbitrary circular or polygonal figures entered by handwriting at respective locations of components which constitute the item of content to be searched for, and symbols (patterns) entered by handwriting within the figures.
regions containing locations of components of an item of content to be searched for
relative relations among regions
classifications of the components

In the example of FIG. 8, a polygon 71 encircling symbols conceptualizing characters is handwritten in an upper section of a page 70, designating that a character region is present somewhere in the upper section. Further, a polygon 72 encircling a symbol conceptualizing a table is handwritten in a lower section of the page 70, designating that a table region is present somewhere in the lower section.

As a symbol conceptualizing a character, for example, a horizontal line (including a wavy or straight line) may be used. The number of horizontal lines may or may not correspond to the number of lines in the character region. As a symbol conceptualizing a table, for example, a lattice may be used. The number of vertical and horizontal lines of the lattice may or may not correspond to the number of rows and columns in the table region.

### Example 4

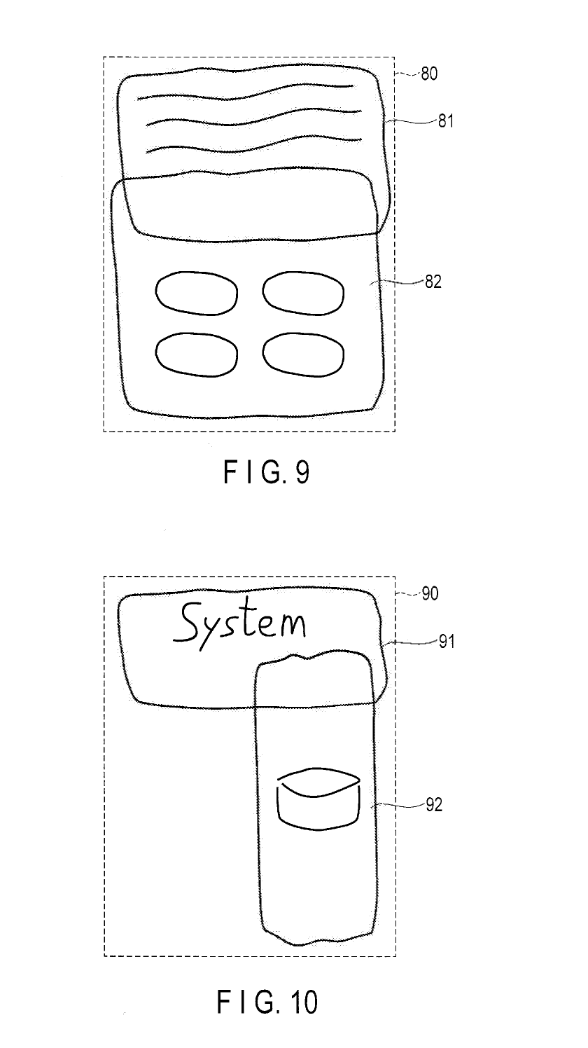

The handwriting data shown in FIG. 9 designates a classification different from that of FIG. 8. In this example, handwriting a polygon 82 containing a symbol conceptualizing a figure on a page 80 in a lower section thereof designates that there is a figure region somewhere in the lower section. As a symbol conceptualizing a figure, for example, an ellipse may be used.

Note that FIGS. 8 and 9 show examples in which a symbol conceptualizing characters is a horizontal line, a symbol conceptualizing a figure is an ellipse, or a symbol conceptualizing a table is a lattice. These conceptualized symbols may be increased or modified by additional leaning and the like.

### Example 5

The handwriting data shown in FIG. 10 designates the following items by arbitrary circular or polygonal figures entered by handwriting at respective locations of components which constitute the item of content to be searched for.
regions containing locations of components of an item of content to be searched for
relative relations among regions

Further, the handwriting data here designates at least one of characters and figures to be searched for by at least one of characters and figures handwritten in the figures.

In this case, the search unit 21 is supposed to search for an item of content whose similarity between the search query and the structural information exceeds a threshold and which contains at least one of characters and figures handwritten at the designated locations, as an item of content to be searched for from the one or more items of content stored in the storage unit 11.

In the example of FIG. 10, a polygon 91 is handwritten in an upper section of a page 90 and a character string “System” is handwritten in the polygon, designating that the keyword “System” is present somewhere in the upper section. Further, a polygon 92 is handwritten in a right side section of the page 90 and a figure of “a cylinder” is handwritten in the polygon, designating that a cylinder is present in the right side section.

When the classification of a component is designated by handwritten characters as in FIG. 10, it is necessary for the generation unit 19 to recognize the handwritten characters by character recognition in order to generate a search query.

Note that in each of the examples shown in FIGS. 6 to 10, handwriting data can be interactively input. Therefore, the items of content described in connection with FIGS. 6 to 10 need not be input at once, but they may be input step by step while monitoring the search results.

For example, after preparing such handwriting data as that shown in FIG. 10, the polygon 92 may be moved by touch-and-drag or the like, and/or the size thereof may be changed, and thus the display of the list of the search result may be updated accordingly.

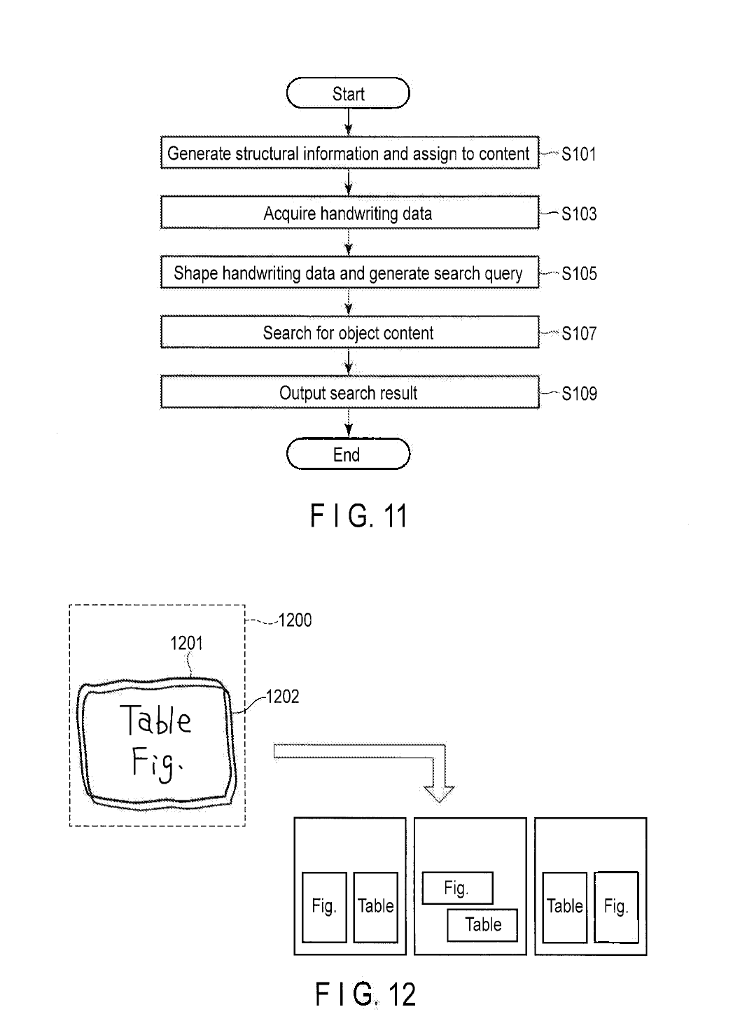

FIG. 11 is a flowchart illustrating an example of a search process executed by a search device 10.

First, the assignment unit 13 analyses the structure of each of contents stored in the storage unit 11. Then, the assignment unit 13 generates structural information indicating a location of each of a plurality of components which constitute each item of content, relative locational relationship among the components and classifications thereof, and assigns the information to the item of content (step S101).

Here, when the user enters handwriting data through the entry unit 15, the acquisition unit 17 acquires the handwriting data (step S103). In the first embodiment, the handwriting data is present around the first region equivalent to the classified-component-presence region in an item of content to be searched for, and designates the second region which limits the likelihood of the presence of the component. The handwriting data input is displayed on the display unit 25 through the display control unit 23.

For example, if the classification of a target component is any type of figure, and the region where the figure is present is clearly known, the region (first region) is designated by handwriting. If the region where the figure is present is not clearly known, the region where the figure is supposed to be present (that is, the second region situated around the first region) should only be designated by handwriting.

The generation unit 19 shapes the handwriting data acquired by the acquisition unit 17, and generates a search query (step S105).

The search unit 21 compares the search query generated by the generation unit 19 with the structural data of each of the one or more items of content stored in the storage unit 11 to search for the target content item (step S107). The search unit 21 searches for content whose similarity between the search query and the structural information exceeds a threshold, as the target content item to be searched for.

The display control unit 23 displays the search result obtained by the search unit 21 in a predetermined format on the display unit 25 (step S109).

Note that the processing steps S101 to 109 in FIG. 11 need not be executed continuously, but step S101 may be executed once in advance.

Further, display of handwriting data and that of a search result may be simultaneously carried out. The completion of acquisition of the handwriting data by the acquisition unit 17, that is, the timing of the pen-up may be used as a trigger to start the process from step S105 on.

As described above, according to the first embodiment, a region where a component of a target content item is present is designated, and thus a content item containing the component in the designated region is searched for as a target content item to be searched for.

Particularly, according to the first embodiment, it suffices only if, not the location where the component is present, but a region where the component is supposed to be present (the second region) is roughly designated. Therefore, even if the content item to be searched for is not clearly remembered, the content item can be searched for.

For example, let us suppose the case of a business notebook in which the names of customers are written on the left end sides of pages, and that the data on each page of the business notebook is stored in the storage unit 11. In this case, the page containing a customer's name can be searched for only by designating a section in the region of the left end side of a page and writing the name of the customer therein.

Let us suppose a case where, for example, all that is remembered is that there were a figure and a table, and the locational relationship thereof is not remembered. In this case, it suffices only if a table region 1201 and a figure region 1202 in a page 1200 are designated at the same location. In this way, the search results can be narrowed down regardless of the locational relationship between the figure and table.

Note that in the example of FIG. 12, to which of the regions 1201 and 1202, a character string (“Table” and “Fig.”) indicating a classification corresponds is determined by the following methods.
a region in which a character string is written closer thereto is set as the region of the classification designated.
a region in which the handwriting of a character string is continuous thereto is set as the region of the classification designated by the character string. In this case, it is also possible to determine that an outline of the region was written immediately before or after the handwriting of the character string.
a region drawn in the same color as that of the character string is set as a region of the classification designated by the character string. In this case, if outlines of the regions are written in different colors, it is possible to determine that a keyword of the same color contained in the region corresponds to the classification.

### Second Embodiment

The second embodiment will now be described.

In this embodiment, search is carried out while designating a region where no component is present (margin or the like). The basic structure of the search device is similar to that of the first embodiment (FIG. 1) except for the functions of an acquisition unit 17 and a search unit 21.

In the second embodiment, the acquisition unit 17 acquires handwriting data indicating a region where none of components which constitute content to be searched for is present, and the classification thereof. That is, the handwriting data of this embodiment designates the entirety or a part of a third region other than the first region equivalent to a classified-component-presence region where a component is present.

For example, when the classification of the component is character, the first region indicates a region where a character is clearly present. By contrast, the third region indicates a region which does not contain a character (margin or the like).

The search unit 21 searches for an item of content to be searched for from the storage unit 11 based on the handwriting data acquired by the acquisition unit 17.

More specifically, the search unit 21 compares a search query generated by the generation unit 19 with the structural data of each of the one or more items of content stored in the storage unit 11, and searches for an item of content to be searched. For example, the search unit 21 searches for an item of content whose similarity between the search query and the structural information exceeds a threshold, as the target content item to be searched for from the one or more items of content stored in the storage unit 11.

The similarity may be defined as (S1−S2)/S1, where S1 represents the area of the third region designated by the handwriting and S2 represents the area where the third region and the first region cross over. Thus, when a component is not present anywhere in the designated region (the third region), the similarity is 100%.

One or more contents stored in the storage unit 11 are each able to derive a location of each of components constituting the item of content itself, a relative locational relationship among components and a classification of each of the components. Therefore, it is also possible that the search unit 21 analyzes each item of content stored in the storage unit 11, and derives the location of each of the components, the relative locational relationship among the components and the classification of each of the components based on the result of analysis. Then, the search unit 21 may compare these with a search query generated by the generation unit 19 to search for an item of content to be searched for. In this manner, a target content item can be searched for even if structural information is not assigned to the item of content by the assignment unit 13.

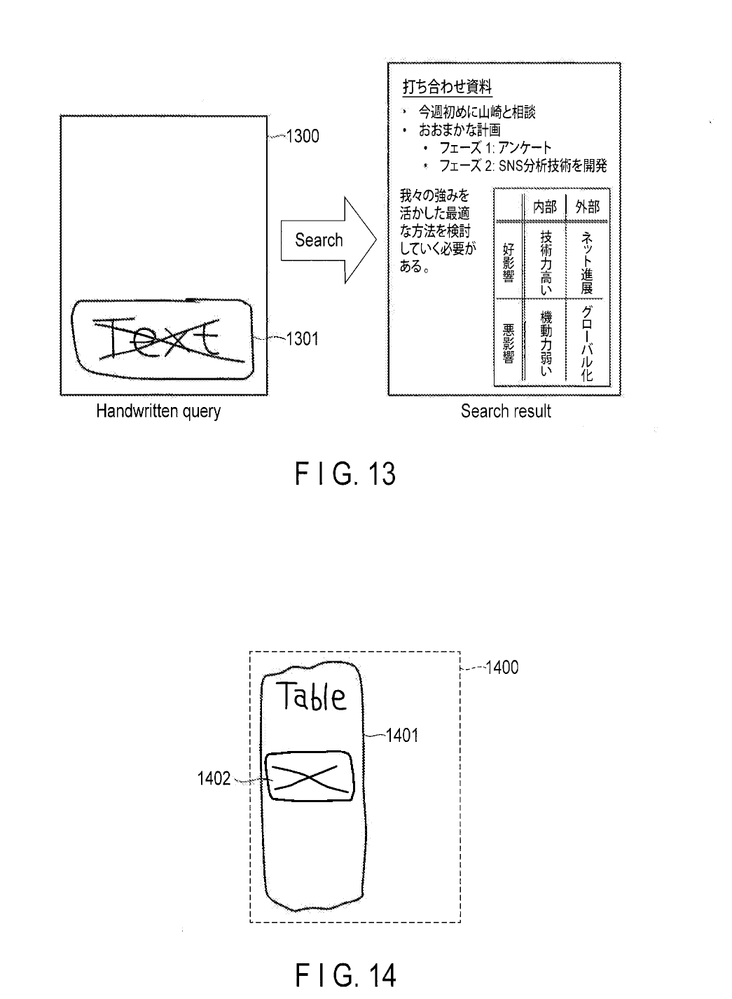

FIG. 13 shows an example of handwriting data in the second embodiment.

The handwriting data shown in FIG. 13 designates the following items by arbitrary circular or polygonal figures entered by handwriting at respective locations of components which constitute the item of content to be searched for, characters entered by handwriting within the figures, and writing “×” on the characters.
regions not containing components of an item of content to be searched for
relative relations among the regions not containing components
classifications of the components

In the example of FIG. 13, a polygon 1301 which does not contain characters is handwritten in a lower section of a page 1300, designating that a character region is not present anywhere in the lower section. As to the type of characters, those mentioned in the first embodiment may be used. Note that not only characters, an expression by conceptualization may be used. Further, when the classification is not designated, a region where there is no handwriting may be an object to be searched for.

In order to distinguish this embodiment from the designation method of the first embodiment, such a description as “margin”, “space” or “none” may be used to designate a region where no component is present.

Alternatively, as in the example of FIG. 13, the conceptual figure “×” may be used as well. Further, the outline of the figure (circle or polygon) to designate a region may be written in dots, or with a white pen.

As described above, according to the second embodiment, content can be searched for by designating a region where no component is present. Particularly, in the second embodiment, content is searched for based on a handwritten query indicating a location of a region where no component is present. Therefore, a target content item can be searched for even if the memory is unclear such that “there was no character in this section” or “there was no figure in this section”.

Let us suppose, for example, that there is a page on which an upper right side thereof is left as a margin for a note which may be added later. In this case, a page which contains the above-mentioned margin can be searched for by designating the region where no component is present is to the upper right of a page.

### Third Embodiment

The third embodiment will now be described.

In this embodiment, search is carried out while designating a region where no component is present (margin or the like). This embodiment is different from the second embodiment in a storage unit 11 and a search unit 21.

The storage unit 11 stores regions where the likelihood of presence of the target component is at a threshold value or less, while associating them with the respective items of content. When, for example, the classification of the component is character, “a region where the likelihood is at a threshold value or less” means a region which contains a component of some other classification than character.

The search unit 21 searches content to be searched for from the storage unit 11 based on the handwriting data acquired by the acquisition unit 17. In this embodiment, the search unit 21 refers to the structural data of each of the one or more items of content stored in the storage unit 11, and searches for the content to be searched for. For example, the search unit 21 searches for content whose similarity between the search query and the structural information exceeds a threshold, as the target content item to be searched for from the one or more items of content stored in the storage unit 11.

The similarity may be defined as, for example, a ratio in coincidence between a region designated by handwriting data and a region in which the likelihood is at a threshold value or less.

As described above, according to the third embodiment, a region where no component is present is designated as in the second embodiment, and in this way, content which does not contain the component in the designated region can be searched for as the content to be searched for.

Particularly, in the third embodiment, the location of a region where the likelihood of presence of a component is at a threshold value or less is stored as the structural data of content. Therefore, a target content item can be searched for even if a designation is indicated in such a negative way that, for example, “a component which is not a character was in this section” or “a component other than a figure was in this section”.

### Fourth Embodiment

The fourth embodiment will now be described.

In this embodiment, two or more components are designated by different methods. More specifically, content is searched for by using two or more designating methods from the following three types,
(1) Designating a location of a component
(2) Designating a region in which a component is present (the designation method of the first embodiment)
(3) Designating a region in which no component is present (the designation method of the second or third embodiment)

The basic structure of the search device is similar to that of the first embodiment (FIG. 1) except for the functions of an acquisition unit 17 and a search unit 21. Further, each of the items of content stored in the storage unit 11 contains at least the first and second classified-component-presence regions.

In the fourth embodiment, the acquisition unit 17 acquires handwriting data indicating two or more designation methods from the above-described three types. These three types of designation methods may be distinguished from each other by, changing the color of the pen, or each type may be set from the menu of the application. Further, the outline of a pattern such as a circle or polygon for designating a region may be written in dots, solid line or double line or the like.

The search unit 21 searches for content to be searched for from the storage unit 11 based on the handwriting data acquired by the acquisition unit 17.

More specifically, the search unit 21 compares the search query generated by the generation unit 19 with the structural data of each of the one or more contents stored in the storage unit 11 to search for the content to be searched for. For example, the search unit 21 searches for content whose similarity between the search query and the structural information exceeds a threshold, as the target content item to be searched for from the one or more items of content stored in the storage unit 11.

The similarity may be defined as, for example, a degree of coincidence between a location designated by handwriting data and a location of a component in content to be searched for. The similarities of the regions designated by the other two types of methods are similar to those already described.

FIG. 14 shows an example of handwriting data in the fourth embodiment.

The handwriting data shown in FIG. 14 designates the following items by arbitrary circular or polygonal figures entered by handwriting at respective locations of components which constitute the content to be searched for, and characters or symbol “×” entered by handwriting within the figure.
regions containing components of content to be searched for, or regions not containing the components
relative relations among the regions
classifications of the components

In the example of FIG. 14, a polygon 1401 which contains a table is handwritten in a left section of a page 1400, designating that a table region is present somewhere in the left section. Further, a polygon 1402 which contains a symbol “×” is handwritten in a middle left section of the page 1400, designating that a region containing no writing (blank region) is present in the middle left section.

As described above, according to the fourth embodiment, content can be searched for by designating regions using two or more of the three types of designation methods. Therefore, target content item can be searched for even if the only item remembered is that a table and a blank were at somewhere in the left side as in the example of FIG. 14.

### Modification 1

In each of the embodiments described above, content to be searched for may be an image (photo) of a person or a face.

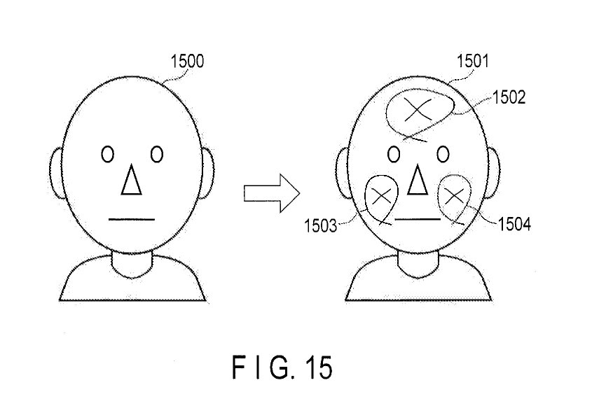

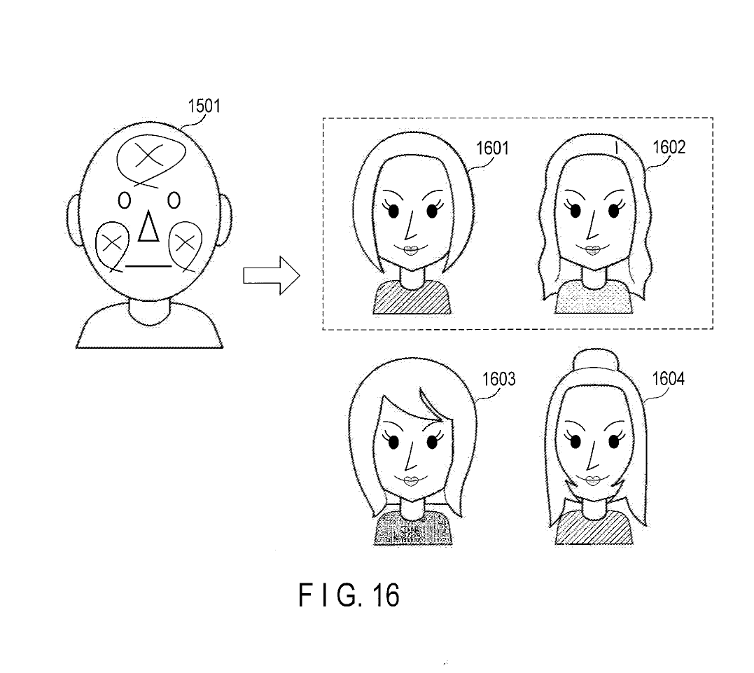

FIG. 15 shows an example of handwriting data in the modification 1. FIG. 16 shows an example of handwriting data together with a search result in the modification 1.

The modification 1 is assumed as a face search app (application). The face search app may be used for such a situation that, for example, a desired hair style or make-up is searched for in a beauty salon. The storage unit 11 shown in FIG. 1 is used as a database for face images. The database stores data of numerous face images in advance.

For example, on a face template 1500 shown in FIG. 15, regions where there is no hair or specific color are designated by handwriting. Handwriting data 1501 indicates a state of the face designated that specific regions of the face (the forehead 1502 and cheeks 1503 and 1504) are not covered with hair.

Note that the data of the face images in the database are normalized in advance, and associated with the locations of parts such as eyes, nose and mouth on the template 1500. For the normalization, a technique of acquiring characteristic points from a face (for example, active shape modeling) and a deformation process for associating the characteristic points with respective parts may be used.

Based on the handwriting data 1501, an image in which the designated regions are not covered with hair is searched for from the face images in the database. More specifically, the characteristic points are extracted from the face images, and a triangle region defined by the characteristic points as its vertexes is made for each face image. Further, based on the variation in brightness within the triangle region, an image with the regions not covered with hair is searched for. Note that a dark section, which has a low brightness, is determined as being covered with hair.

FIG. 16 shows an example of a search result. Images 1601 and 1602, in which the forehead and cheeks are not covered with hair, are output from the database as search results. An image 1603 in which the forehead is covered with hair and an image 1604 in which the cheeks are covered with hair are not output as search results.

### Modification 2

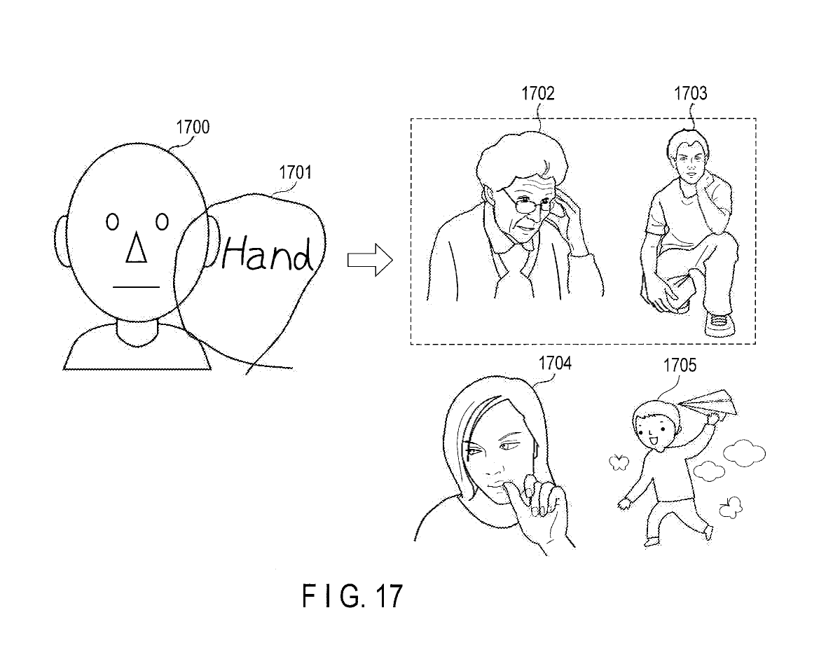

FIG. 17 shows an example of handwriting data together with a search result in the modification 2.

The modification 2 is assumed as a people search app (application). The people search app may be used for such a situation that, for example, an image of a person in a desired pose is searched for from photo albums and library materials. The storage unit 11 shown in FIG. 1 is used as a database for images of persons. The database stores data of images of numerous persons in advance.

Let us suppose a case where it is remembered that a hand was placed near a right side of the face (right-hand side of the viewer). In such a case, on a right side of a face template 1700, a region where there was a hand, that is, region 1701 is designated by handwriting. The faces and hands in the images stored in the database are detected by image processing, and images containing a hand in the designated region 1701 are output as search results.

In the example of FIG. 17, images 1702 and 1703 are output as search results. On the other hand, images 1704 and 1705 are not output as search results since these images contain a hand on a right side of the face, but the hand is located distant from the designated region 1701. Note here that the setting of the threshold value with respect to the designated region may be changed to include images 1704 and 1705 as search results.

### Modification 3

In each of the embodiments described above, content to be searched for may be an electronic clinical chart of a patient.

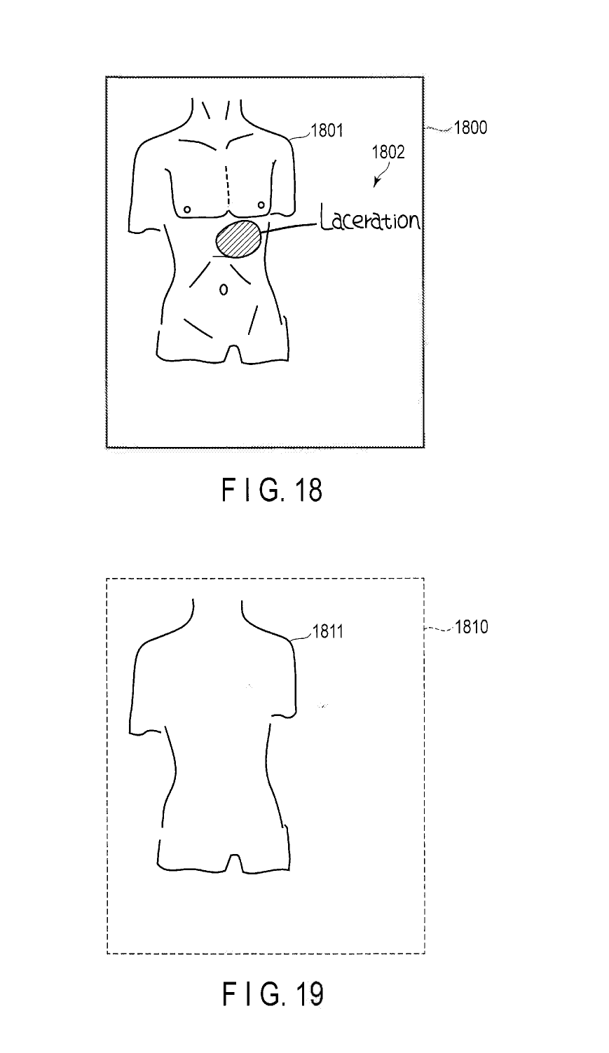

FIG. 18 shows an example of content to be searched for in the modification 3. FIG. 19 shows an example of handwriting data in the modification 3.

As shown in FIG. 18, an upper left of a content item 1800 to be searched for contains a schema region 1801. Let us suppose that a central portion of the schema region 1801 contains an illustration region indicating a location of an affected part and a character region 1802 containing a comment on the affected part. The schema is a template of human body diagram, to which the location of an affected part, comments on the affected part and the like can be written.

A possible example of the handwriting data to search for the target content item 1800 is handwriting data 1811 such as shown in FIG. 19. The handwriting data 1811 is an illustration (a rough sketch) handwritten in a region which contains the location of a component of the target content item, which designates the location of the component of the content and the classification of the component.

More specifically, the handwriting data 1811 designates that the schema region is in the upper left of the page when a rough sketch of schema is handwritten in the upper left of a page 1810.

In the modification 3, the assignment unit 13 generates structural information further containing schema information, and assigns it to content. The schema information includes the location of a schema region, the classification of a template of a schema, etc.

The search unit 21 may be configured to be able to further search for a schema which coincides with a pattern of a rough sketch of handwriting data. In this case, for example, a technique called “chamfer matching” may be used as a matching method for line drawings. This technique is based on a method in which an image whose pixel values are larger as the respective pixels are closer in distance to a line of the line drawings is generated, and the distance between line drawings is obtained from the Euclidian distance between the line drawings. The search unit 21 may search for a template of a schema closest to the handwritten line drawing based on the obtained distance.

### Modification 4

Each of the embodiments provided above is described in connection with an exemplified case where the search device 10 comprises all types of components, but the embodiments are not limited to this. For example, some of the components may be provided outside the search device 10, that is, on the cloud.

(Hardware Configuration)

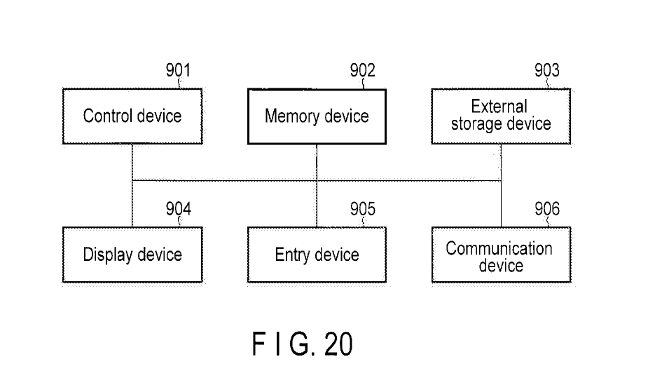

FIG. 20 shows an example of a hardware configuration of the search device in each of the embodiments and modifications.

In each of the embodiments and modifications, the search device 10 comprises a control device 901 such as a CPU, a memory device 902 such as ROM or RAM, an external storage device 903 such as an HDD, a display device 904 such as a display, an entry device 905 such as a keyboard or a mouse, and a communication device 906 such as a communication interface. Thus, the search device has a hardware configuration which utilizes an ordinary computer.

In each of the embodiments and modifications, programs executed by the search device 10 are provided while being stored on a computer-readable memory medium such as CD-ROM, CD-R, memory card, Digital Versatile Disk (DVD), or flexible disk (FD) in an installable or executable format.

Further, in each of the embodiments and modifications, programs executed by the search device 10 may be provided by storing them on a computer connected a network such as the Internet to download via the network. The programs executed by the search device 10 may be provided or distributed via a network such as the Internet. Further, the programs executed by the search device 10 may be provided while incorporating them into a ROM or the like in advance.

Moreover, the programs executed by the search device 10 have module configurations so that the units described above are executed on a computer. As an actual hardware device, the CPU reads the programs from the HDD on the RAM and executes them thereon, and thus the above-described units are executed on the computer.

Although the preferred embodiments have been described above, the embodiments are not limited to those described as they are, but they can be practiced with modifications of the structural elements as long as the essence of the technology does not depart from the scope thereof. Various modifications can be made by combining structural components disclosed in the embodiments appropriately. For example, some elements may be deleted from the structural elements which constitute each of the embodiments, or elements of different embodiments may be combined together as needed.

For example, the steps in the flowcharts of each of the embodiments may be changed in the order of execution or some of them may be executed simultaneously, or in different orders from one embodiment to another unless the rearrangement does not contradict the originally designed mechanisms.

According to at least one of the embodiments described above, content to be searched for can be searched for by designating a region which contains a component of the content, or a region which does not contain a component.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A search device comprising:
a storage to store one or more items of content and store a classified-component-presence region where a component is present which constitutes a respective one of the one or more items of content while associating the classified-component-presence region with the respective one of the items of content;
an acquisition controller to acquire designation data designating a second region which is located around a first region equivalent to the classified-component-presence region of an item of content to be searched for and limits a likelihood of presence of the component;
a search controller to search for the item of content to be searched for from those stored in the storage based on the designation data acquired by the acquisition controller; and
a display controller to display a search result obtained by the search controller on a display.

2. A search device comprising:
a storage to store one or more items of content and store a classified-component-presence region where a component is present which constitutes a respective one of the one or more items of content while associating the classified-component-presence region with the respective one of the items of content;
an acquisition controller to acquire designation data designating an entirety or a part of a third region which is other than a first region equivalent to the classified-component-presence region of an item of content to be searched for;
a search controller to search the item of content to be searched for from those stored in the storage based on the designation data acquired by the acquisition controller; and
a display controller to display a search result obtained by the search controller on a display.

3. The search device of claim 2, wherein the storage stores a region whose likelihood of presence of the component is at a predetermined value or less, while associating the region with the respective one of the items of content.

4. The search device of claim 1, wherein
each of the one or more items of content stored in the storage contains at least first and second classified-component-presence regions, and
the designation data designates the second region which is present around the first region equivalent to the first classified-component-presence region of an item of content to be searched for and limits the likelihood of presence of the component, and a fourth region equivalent to the second classified-component-presence region in the item of content to be searched for.

5. The search device of claim 2, wherein
each of the one or more items of content stored in the storage contains at least first and second classified-component-presence regions, and
the designation data designates an entirety or a part of a third region which is other than a first region equivalent to the first classified-component-presence region of an item of content to be searched for, and a fourth region equivalent to the second classified-component-presence region in the item of content to be searched for.

6. A search device comprising:
a storage to store one or more items of content and store a classified-component-presence region where a component is present which constitutes a respective one of the one or more items of content while associating the classified-component-presence region with the respective one of the items of content;
an acquisition controller to acquire designation data designating a margin region which is other than the classified-component-presence region of an item of content to be searched for;
a search controller to search the item of content to be searched for which contains the margin region from the one or more items of content stored in the storage based on the designation data acquired by the acquisition controller; and
a display controller to display a search result obtained by the search controller on a display.

7. The search device of claim 1, wherein the designation data is handwriting data comprising a plurality of strokes.

8. The search device of claim 2, wherein the designation data is handwriting data comprising a plurality of strokes.

9. The search device of claim 6, wherein the designation data is handwriting data comprising a plurality of strokes.

10. The search device of claim 1, wherein the designation data further designates a classification of the component.

11. The search device of claim 2, wherein the designation data further designates a classification of the component.

12. The search device of claim 6, wherein the designation data further designates a classification of the component.

13. The search device of claim 10, wherein the classification of the component is one of character, pattern, table, image, illustration, formula, map and memo additionally written by a user.

14. The search device of claim 11, wherein the classification of the component is one of character, pattern, table, image, illustration, formula, map and memo additionally written by a user.

15. The search device of claim 12, wherein the classification of the component is one of character, pattern, table, image, illustration, formula, map and memo additionally written by a user.
